(19) United States
(12) Patent Application Publication
(10) Pub. No.: US 2020/0365282 A1
(43) Pub. Date: Nov. 19, 2020

(54) Corkscrew Nuclear Fusion Reactor

(71) Applicant: George Pul, Las Vegas, NV (US)

(72) Inventor: George Pul, Las Vegas, NV (US)

(21) Appl. No.: 16/409,869

(22) Filed: May 13, 2019

(51) Int. Cl. G21B 1/05; G21B 1/17

(52) U.S. Cl. CPC G21B 1/05; G21B 1/17

(57) ABSTRACT

Corkscrew Nuclear Fusion Reactor (Corkscrew NFR) of the present invention fuses, ignites, and burn in sustained nuclear fusion reactions of plasma ions within a linear axisymmetric vacuum chamber; and it builds upon parts of many currently known NFRs with some new features to make Corkscrew NFR a simplified, compact, productive, and low cost NFR. Corkscrew NFR comprises some unique but simple assemblies and methods, including: the use of a centrifuge and a cone to originate and then to shape a slow forward moving coherent beam of plasma ions from the shape of a cylinder to the shape of a corkscrew. A corkscrew beam of plasma ions orbital rotations are greatly concentrated moving forward in a corkscrew shape from a large diameter to nearly a point. Other not so unique assemblies and methods commonly found on current NFRs are used to super heat, accelerate, focus, steer, and compress beams of plasma ions, causing plasma ions to become dense enough at high enough temperature for long enough period of time to fuse, ignite, and burn in sustained nuclear fusion reactions.

### FIELD

The present invention relates generally to magnetic confinement Nuclear Fusion Reactors (NFRs), and more particularly, the present invention relates to linear magnetic confinement NFRs featuring two counter rotating beams of plasma ions, originated in the shape of corkscrews, and violently colliding head-on.

### BACKGROUND OF THE INVENTION

NFRs by magnetic or inertia confinements have been a moving 30 years targets of promises ever since when they were first proposed nearly a century ago. Given the promises of nearly unlimited clean and free energies, we yet have today not even a test NFR that generates a net power output than power consumed. Corkscrew Nuclear Fusion Reactor, or Corkscrew NFR, of the present invention builds upon parts of many currently known NFRs with some unique and simple features; and for been simple, compact, productive, and low cost, Corkscrew NFR is most likely to fulfill the promises within the next 30 years.

### SUMMARY OF THE INVENTION

Corkscrew Nuclear Fusion Reactor, or Corkscrew NFR, of the present invention fuse and ignites nuclear fusion reactions of plasma ions within an axisymmetric vacuum chamber; it builds upon parts of many currently known NFRs with some new features; it is a simple, compact, productive, and low cost NFR for employing some unique, but relatively simple assemblies and some other not so unique assemblies commonly found on current NFRs. Corkscrew NFR is a linear magnetic confinement NFR, and is generally an axisymmetric shell structure of revolution with an axis of axisymmetry along its length. At halfway along its length is a mid-plane of rotational symmetry, dividing Corkscrew NFR into two axisymmetric and rotational opposite halves. On either side of the mid-plane of rotational symmetry, each of two rotational opposite halves of Corkscrew NFR comprises a unique but relatively simple centrifuge assembly and portions of a stationary shaft and base assembly; and a rotational opposite half also comprises assemblies commonly found on current NFRs, including: portions of a stationary shaft and base assembly, a linear accelerator assembly, and half of a combustion chamber assembly. A complete combustion chamber assembly straddles equally across Corkscrew NFR mid-plane of rotational symmetry. Each of two rotational opposite halves of Corkscrew NFR is half of a complete vacuum chamber fixed jointed together by a stationary shaft and base assembly, a linear accelerator assembly, and half of a complete combustion chamber assembly; and a centrifuge assembly is contained within half of the vacuum chamber.

A centrifuge assembly, contained within the airtight vacuum chamber, is consisted of a rotating cup and very low friction bearings; and the rotating cup has both a very fast spin rate and a large diameter rotating cup. A stationary shaft and base assembly consists of a stationary shaft, a solenoid magnet, a fixed ground support, and one outer and one inner base cup and cone subassemblies; and the outer and the inner base cup and cone subassemblies, short for cones, are unique to Corkscrew NFR. A linear accelerator assembly is consisted of an accelerator mounted on a housing tube that is in between and fixed connected at one end to the outer base cup and cone subassembly, and at the other end to a combustion chamber small tapered end. A combustion chamber assembly, half of which is on either side of the mid-plane of rotational symmetry, is consisted of a chamber body of a large center cylinder with two small tapered ends, and a separate and isolated solenoid magnet surrounds each of two halves of the combustion chamber body. The stationary shaft and base assembly supports the centrifuge assembly through centrifuge very low friction bearings. The inner cone is nested within the centrifuge rotating cup to form a cylindrical flow channel for injected low pressure gas particles and freed plasma ions. The nested outer and inner cones provide a conical flow channel for a beam of plasma ions flowing forward in the shape of a corkscrew. Positively charged particles filled non-conducting inner cone generates electrical repulsive forces on the forward flowing corkscrew beam of plasma ions.

Corkscrew NFR is further comprised of not so unique assemblies and systems found on many currently known NFRs; and these required assemblies and systems for Corkscrew NFR are briefly described here and are fully described only by references to currently known NFRs. Such not so unique but required assemblies and systems include: a power and control systems for spinning a centrifuge, energizing solenoid magnets, and supplying vacuums to the vacuum chamber; a linear accelerator assembly to accelerate forward, focus, and steer a beam of plasma ions; a heating systems to heat and convert gas particles into plasma ions and electrons, and to superheat plasma ions to extremely high temperatures required for nuclear fusion reactions; an electric and magnetic fields confinement systems to keep beams of plasma ions confined; and magnetic cusps present at the mid plane of rotational symmetry to trap, confine, and compress two violently colliding counter-rotating beams of plasma ions to fuse, ignite and burn in a nuclear fusion reaction.

In operation, Corkscrew NFR is unique in generating and shaping a coherent cylindrical beam of plasma ions into the shape a corkscrew. For each of two rotational opposite halves of Corkscrew NFR, a centrifuge spins up a slow forward flowing gas within a nearly perfect vacuum chamber; and pressed against its cup side wall, the slow forward flowing gas is cylindrical in shape and coherent in having the same high orbiting speed and large radius of the centrifuge. The centrifuge heats and converts the gas into a cylindrical coherent plasmas of free ions and electrons; magnetic and electric fields repel the hot plasma ions away as free flowing plasma ions to flow forward without frictions in a cylindrical flow channel formed in-between the centrifuge side wall and the inner cone; and plasma electrons are attracted into and removed from the centrifuge side wall. Nested in-between inner and outer cones is a conical flow channel that channels and conforms the coherent beam of plasma ions, originated in the centrifuge in the shape of a cylinder, into the shape of a corkscrew, and flowing forward from the conical flow channel large end to a pointed end. Within the conical flow channel, forward flowing plasma ions in magnetic fields are subjected to three primary forces: the orbital centripetal inertia forces, the magnetic confinement forces, and the electrical repulsive forces from the inner cone filled with positively charged particles. For corkscrew plasma ions flowing forward without frictions, the three primary applied forces are balanced to net zero in radial force component, and to net forward in forward force component. In flowing forward from the conical flow channel large end to a pointed end, the coherent corkscrew beam of plasma ions flows forward with ever smaller radius, getting ever hotter, denser, narrower, and faster in both orbital and forward speed until it enters into a small diameter linear accelerator.

Corkscrew NFR is not so unique in operations to accelerate, superheat, confine and compress plasma ions by the use of a linear accelerator, multiple heating elements such as RF heating, magnetic confinements, and magnetic cusps commonly found on currently known NFRs. A linear accelerator speeds up, focuses, steers, and transforms the corkscrew beam of plasma ions entering the linear accelerator. Upon entering half of the combustion chamber, been superheated passing through half of the combustion chamber, and hitting on-target on the mid-plane of rotational symmetry, each of two forward flowing coherent counter-rotating beams of plasma ions is at the maximum for extremely high temperature and density, extremely fast in orbital and forward speed, and extremely small in orbital radius. Magnetic cusps at mid-plane of rotational symmetry trap, confine, and compress violently head-on collisions of the two beams of plasma ions. And plasma ions, by been dense enough at high enough temperature for long enough period of time, are fused, ignited, and burned in sustained nuclear fusion reactions.

Corkscrew NFR of the present invention is novel for comprising a centrifuge assembly and portions of a stationary shaft and base assembly; for originating a coherent beam of plasma ions in the shape of a cylinder from within the centrifuge; and for shaping the cylindrical coherent beam of plasma ions into the shape a corkscrew. Corkscrew NFR employs many not so unique assemblies and methods commonly found on current NFEs. These unique and not so unique but essential assemblies and methods are described in more details as appropriate for the preferred embodiment of Corkscrew NFR of the present invention.

### BRIEF DESCRIPTION OF THE DRAWINGS

FIG. 1 is an axisymmetric cross section view of one of two rotational opposite halves of the preferred embodiment of the present invention about the mid-plane of rotational symmetry.

FIG. 2 is a schematic view of FIG. 1 showing generally the magnetic field lines and the three primary forces acting on plasma ions.

FIG. 3 is a close up detail view of magnetic cusp field lines taken from Detail Callout 3 of FIG. 2.

### DESCRIPTION OF THE PREFERRED EMBODIMENT

Corkscrew Nuclear Fusion Reactor, or Corkscrew NFR, of the present invention is disclosed by a preferred embodiment, which is a simplified Corkscrew NFR to show with clarity its features and advantages for been a simple, compact, productive, and low cost NFR. These and other features and advantages of the present invention will become more apparent to one skilled in the art from the following description and claims when read in light of the accompanying drawings for the preferred embodiment of a simplified present invention.

Unless otherwise apparent, or stated, directional references, such as “inner,” “inward,” “outer,” “outward,” “downward,” “upper”, “lower” etc., are for non-limiting descriptive purposes and intended to be relative to the orientation of a particular Corkscrew NFR of the present invention as shown in the view of that apparatus. Parts shown in a given FIGURE may generally be proportional in their dimensions.

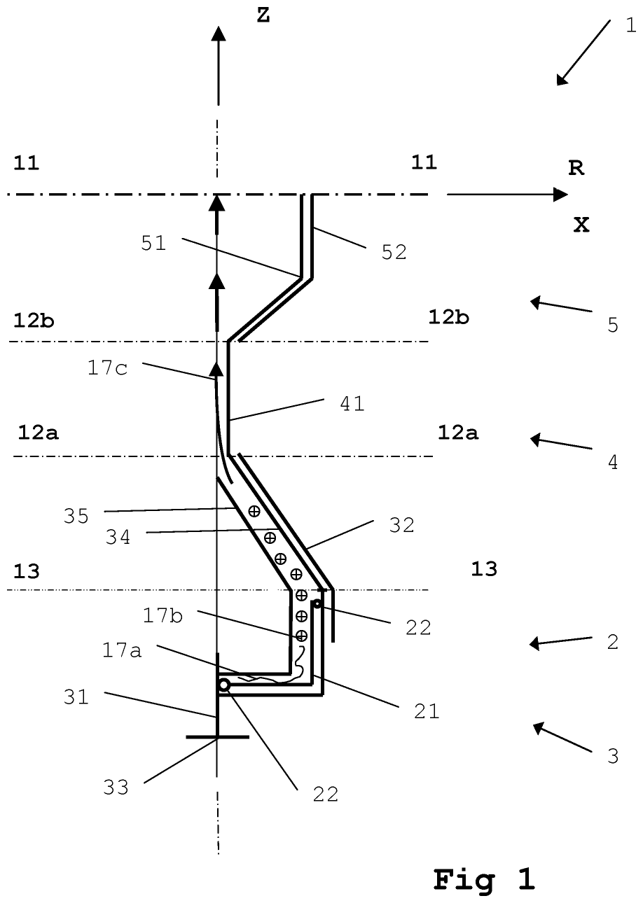

Referring to FIGS. 1 through 3, preferred embodiment 1 of Corkscrew NFR of the present invention is a linear magnetic confinement NFR, and it is generally an axisymmetric shell structure of revolution with an axis of axisymmetry along its length. At halfway along its length is a mid-plane of rotational symmetry 11 dividing preferred embodiment 1 into two axisymmetric and rotational opposite halves; and each of two rotational opposite halves of preferred embodiment 1 comprises: centrifuge assembly 2, stationary shaft and base assembly 3, linear accelerator assembly 4, and half of combustion chamber assembly 5. A complete combustion chamber assembly 5 straddles equally across mid-plane of rotational symmetry 11. Stationary shaft and base assembly 3 and linear accelerator 4 are airtight fix jointed at plane 12a; and linear accelerator 4 and combustion chamber 5 are airtight fix jointed at plane 12b. Stationary shaft and base assembly 3 has intermediate plane 13 separating base cups from cones of both outer and inner base cup and cone subassemblies 34 and 35, respectively.

Preferred embodiment 1 of two halves has vacuum chamber 18 assembled from (2) stationary shaft and base assembly 3, (2) linear accelerator assembly 4, and (1) combustion chamber assembly 5, airtight fixed jointed together at planes 12a and 12b; and within vacuum chamber 18 are (2) centrifuge assembly 2. Centrifuge assembly 2 and cup and cone subassemblies 34 and 35 of stationary shaft and base assembly 3 are unique but relatively simple assemblies of preferred embodiment 1; and other portions of stationary shaft and base assembly 3, linear accelerator assembly 4, and combustion chamber assembly 5 are commonly found on current NFRs, and are not unique to preferred embodiment 1. Preferred embodiment 1 has an X-Y-Z and R-O-Z coordinate systems with X and R axis pointing to the right in the mid-plane of rotational symmetry 11, and +Z pointing forward on the axis of axisymmetry.

Centrifuge assembly 2, contained within the airtight vacuum chamber 18, is consisted of a rotating cup 21 and very low friction bearings 22; and rotating cup 21 has both a very fast spin rate and a large diameter. Stationary shaft and base assembly 3 consists stationary shaft 31, solenoid magnet 32, fixed ground support 33, and outer and inner base cup and cone subassemblies 34 and 35, respectively. Linear accelerator assembly 4 is consisted of accelerator 41 mounted on accelerator housing tube 42 which is in between and connected to stationary shaft and base assembly 3 and combustion chamber 5. Combustion chamber assembly 5, one of two halves on either side of the mid-plane of rotational symmetry 11, is consisted of a chamber body 51 made of a large center cylinder with two tapered smaller ends, and one solenoid magnet 52 for each of two halves of combustion chamber body 51. Stationary shaft and base assembly 3 supports centrifuge assembly 2 through very low friction bearings 22. Accelerator housing tube 42 is airtight fixed connected at the aft end on plane 12a to outer base cup and cone subassembly 34, and at the forward end on plane 12b to tapered smaller end of combustion chamber body 51. Inner base cup and cone subassembly 35 is nested within centrifuge rotating cup 21 to form a cylindrical shaped flow channel for the forward flow of injected low pressure gas particles 17a and freed plasma ions 17b. The nested outer and inner base and cone subassemblies 34 and 35, short for cones 34 and 35, form a conical flow channel for the forward flow of beam of plasma ions 17b.

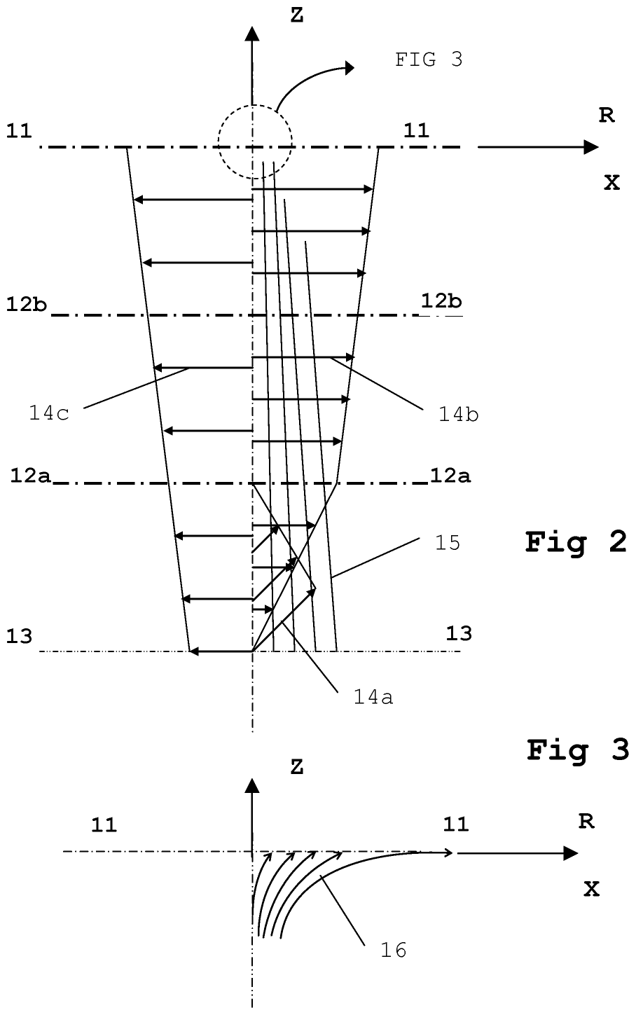

Referring particularly to FIGS. 2 and 3, beam of plasma ions 17b is subjected to magnetic field 15, electrical repulsive forces 14a, centripetal inertia forces 14b, and magnetic confinement forces 14c. Electrical repulsive forces 14a is from non-conducting inner base and cone subassembly 35 filled with positively charged particles. Self induce centripetal inertia forces 14b is from Plasma ions 17b in orbital rotations. Magnetic field lines 15 generate magnetic confinement forces 14c on plasma ions 17b. And magnetic field lines 15 meeting at mid-plane of rotational symmetry 11 produce magnetic cusp 16.

Preferred embodiment 1 has power and control systems for spinning centrifuge assembly 2, energizing solenoid magnets 32 and 52, and supplying vacuums to vacuum chamber 18. It has linear accelerator assembly 4 to accelerate forward, focus, and steer beam of plasma ions 17b. It has a heating system through RF heating, ohms resistance heating, and neutron beams heating to superheat beam of plasma ions 17b to extremely high temperatures required for nuclear fusion reactions. It has an electric and magnetic fields confinement systems to keep beam of plasma ions 17b confined. And it has magnetic cusps 16 at mid plane of rotational symmetry 11 to trap, confine, and compress two violently colliding counter-rotating beams of plasma ions 17b, and to fuse, ignite and burn plasma ions 17b in a nuclear fusion reaction. These and other systems required for preferred embodiment 1 are neither novel nor unique, and are not further described.

In operations, referring to FIGS. 1 thru 3 for preferred embodiment 1 of Corkscrew NFR of the present invention, beam of plasma ions 17b within vacuum chamber 18 flows forward without frictions in a forward flow path 17c. Beam of plasma ions 17b originated from within centrifuge assembly 2 in a cylindrical flow channel, and ended on-target on plane of rotational plane of symmetry 11, flowing forward in sequences through: stationary shaft and base assembly 3 flowing forward in a conical flow channel, linear accelerator assembly 4 flowing forward in a long and narrow cylindrical channel, and flowing forward through half of combustion chamber 5. Beam of plasma ions 17b, been originated with a very large orbital radius and ended on target with a very small orbital radius, is controlled and guided as it flows forward without frictions along its flow path 17c, passing through at times electrical and magnetic fields and subjected to various forces. Shown particularly in FIG. 2 is a schematic summary of beam of plasma ions 17b flowing forward in magnetic field 15 in its entire flow path 17c, subjected to centripetal inertia forces 14b from its orbital rotations, magnetic confinement forces 14c from magnetic field 15, and electrical repulsive forces 14a from positive charged particles sealed within non-conducting inner base cup and cone subassembly 35. The distance between planes 13, 12a, 12b, and 11 along the Z axis are normalized; and a much magnified narrow band of magnetic field 15, narrowed enough to pass through the small flow channel of linear accelerator 4, is shown next to the axis of axisymmetry. The three forces applied on beam of plasma ions 17b along its flow path 17c are balanced to have a net zero radial forces in R axis and net forward forces in Z axis.

Preferred embodiment 1 of Corkscrew NFR of the present invention is unique in operation for generating and shaping a coherent beam of plasma ions 17b, from the shape of a cylinder into the shape of a corkscrew. Referring back to FIG. 1, for each of two rotational opposite halves of preferred embodiment 1, centrifuge 2 spins up a slow forward flowing gas 17a within a nearly perfect vacuum chamber 18; pressed against rotating cup 21 side wall, the slow forward flowing gas 17a is cylindrical in shape and coherent in having the same high orbiting speed and large radius as of rotating cup 21. Centrifuge 2 heats and converts gas 17a into coherent plasmas ions 17b and electrons; magnetic and electric fields repel hot plasma ions 17b away as free cylindrical forward flowing plasma ions 17b flowing without frictions in the cylindrical flow channel in-between centrifuge rotating cup 21 side wall and inner base cup and cone subassembly 35; and plasma electrons are attracted into and removed from centrifuge rotating cup 21 side wall. A conical flow channel in-between nested cones subassemblies 34 and 35 channels and conforms coherent cylindrical beam of plasma ions 17b, flowing forward from the conical flow channel large end to pointed end, into the shape of a corkscrew. Referring in particular to FIG. 2, Corkscrew beam of plasma ions 17b is subjected to orbital centripetal inertia forces 14b, magnetic confinement forces 14c, and electrical repulsive forces 14a from positive charged particles filling non-conducting inner cone subassembly 35. These three forces applied on corkscrew beam of plasma ions 17b are balanced to have a net zero radial forces in R axis and net positive forward forces in Z axis; and beam of plasma ions 17b, with applied forces in balance, flows freely forward without frictions in the conical flow channel. In flowing forward from the conical flow channel large end to pointed end, the coherent corkscrew beam of plasma ions 17b flows forward with ever smaller radius, getting ever hotter, denser, narrower, and faster in both orbital and forward speed until it enters into a small diameter cylindrical flow channel of linear accelerator assembly 4.

Preferred embodiment 1 of Corkscrew NFR of the present invention is not so unique in operation for accelerating, superheating, confining and compressing plasma ions 17b by the use of assemblies and systems commonly found on currently known NFRs, including: linear accelerator 4; multiple heating elements such as RF heating; magnetic confinements by solenoid magnet 32 and 52; and magnetic cusps 16. Linear accelerator 4 transforms the input corkscrew beam of plasma ions 17b into a very narrow beam of pulsed and segmented plasma ions 17b; and it speeds up, focuses, and steers beam of plasma ions 17b. After passing through and been superheated in combustion chamber 5, beam of plasma ions 17b hits on-target on the mid-plane of rotational symmetry 14. Upon hitting on-target, each of two forward moving coherent counter-rotating beams of pulsed and segmented plasma ions 17b is at the maximum for extremely high temperature and density, extremely fast in orbital and forward speed, and extremely small in orbital radius. On-target at mid-plane of rotational symmetry 15, magnetic cusp 16 shown particularly in FIG. 3 traps, confines, and compresses violently head-on collisions of the two beams of plasma ions 17b. And plasma ions 17b, by been dense enough at high enough temperature for long enough period of time, are fused, ignited, and burned in sustained nuclear fusion reactions.

The preferred embodiment described above is for the purpose of describing features and technical conceptions of a simplified Corkscrew NFR of the present invention. But it should be readily apparent that the invention is not limited to the described preferred embodiment alone, and a person skilled in the art may come up with various changes and modifications consistent to the technical concept disclosed herein and within the spirit and scope of the invention. Prime examples of changes and modifications to the described preferred embodiment include: replacement of repulsive forces from inner cone filled with positively charged particles; number of magnetic cusps; axisymmetric neutron beam heating; and multiple number of halves of Corkscrew NFR, such as an assembly of three halves of Corkscrew NFR. These and other changes are potential optimization variables for Corkscrew NFR; and the described preferred embodiment of Corkscrew NFR may even be adapted for other applications, such as the core power engines for planetary and outer space travels and explorations. Required systems such as power motors and pumps, power supply and controls are neither novel nor unique systems, and are not described in detail for the preferred embodiment of the present invention. Therefore, it is to be understood that modifications and variations may be utilized without departure from the spirit and scope of the invention disclosed herein, as those skilled in the art will readily understand. Such modifications and variations are considered to be within the purview and scope of the claimed invention and their equivalents.

I claim:

1. Corkscrew Nuclear Fusion Reactor, or Corkscrew NFR, fuses and ignites nuclear fusion reactions of plasma ions within an axisymmetric vacuum chamber; it is a simple, compact, productive, and low cost NFR for its employment of some unique but relatively simple assemblies, and some not so unique assemblies commonly found on current NFRs; it is primarily an axisymmetric shell structure of revolution with an axis of axisymmetry along its length, and at halfway along its length is a mid-plane of rotational symmetry dividing Corkscrew NFR into two axisymmetric and rotational opposite halves; and it comprises for each rotational opposite halves a centrifuge assembly, a stationary shaft and base assembly, a linear accelerator assembly, and half of a combustion chamber assembly, wherein:
a) A centrifuge assembly, contained within the airtight vacuum chamber, is unique to Corkscrew NFR, and consists a rotating cup and very low friction bearings; and the rotating cup has both a very fast spin rate and a large diameter;
b) A stationary shaft and base assembly consists of a stationary shaft, a solenoid magnet, a fixed ground support, and an outer and an inner base cup and cone subassemblies; the outer and the inner base cup and cone subassemblies are unique to Corkscrew NFR; the outer base cup and cone subassembly supports the centrifuge assembly through centrifuge very low friction bearings; the inner base cup and cone subassembly nests within the centrifuge rotating cup to form a cylindrical flow channel for injected low pressure gas particles and freed plasma ions; nested in-between outer and inner base and cone subassemblies is a conical flow channel for a forward flowing beam of plasma ions in the shape of a corkscrew; and the closed cavity of the inner base and cone subassembly, been non-conducting, is filled with a volume of positively charged particles to provide repulsive forces to the beam of plasma ions flowing forward in the conical flow channel;
c) A linear accelerator assembly consists a linear accelerator mounted internal to a housing tube that is in between and fixed connected at one end to the outer base cup and cone subassembly, and at the other end to a small tapered end of a combustion chamber body;
d) A combustion chamber assembly, half of which is on either side of the mid-plane of rotational symmetry, consists a chamber body of a large center cylinder with two small tapered ends; and a separate and isolated solenoid magnet surrounds each of two rotational halves of the combustion chamber body;

2. Corkscrew NFR, as recited in claim 1, is further comprised of assemblies and systems found on many currently known NFRs; these required assemblies and systems for Corkscrew NFR are briefly described here and are fully described only by references to currently known NFRs; and such required assemblies and systems include: a power and control systems for spinning centrifuges, energizing solenoid magnets, and supplying vacuums to the vacuum chamber; a linear accelerator to focus, steer and accelerate forward a beam of plasma ions; a heating systems to heat and convert gas particles into plasmas ions and electrons, and to superheat plasma ions to extremely high temperatures required for nuclear fusion reactions; an electric and magnetic fields confinement systems to keep a beam of plasma ions confined; and magnetic cusps present at the mid plane of rotational symmetry to trap, confine, and compress two violently colliding counter-rotating beams of plasma ions into required conditions to fuse and ignite and burn in a nuclear fusion reaction;

3. Corkscrew NFR, as recited in claim 2, employs methods to fuse and ignite nuclear fusion reactions of plasma ions; and been a relatively simple, compact, productive, and low cost NFR, Corkscrew NFR comprises some unique but relatively simple methods, including: a method to generate and shape an orbital rotating coherent beam of plasma ions in a corkscrew shape, wherein:
a) a centrifuge rotates and presses against its cup side wall a slow forward flowing gas into a coherent gas orbiting at same high speed and large radius of the centrifuge about the axis of axisymmetry; the centrifuge heats and converts the gas into a coherent plasmas of free ions and electrons; magnetic and electric fields repel plasma ions away from the side wall as free forward flowing plasma ions in a cylindrical flow channel in-between the centrifuge rotating cup and the inner base cup and cone subassembly; plasma electrons are attracted into and removed from the centrifuge side wall; a cylindrical coherent slow forward flowing beam of plasma ions is hot, having nearly same orbital high speed and large radius as the centrifuge; and a coherent gas or plasma of ions is coherent in having at anyone point along its forward motion the same orbital rotating speed and radius;
b) a conical flow channel in-between the outer and the inner cone and base cup subassemblies, short for inner and outer cones, channels and conforms a forward flowing coherent beam of plasma ions, originated from the centrifuge in the shape of a cylinder, into the shape of a corkscrew; in flowing forward from the conical flow channel large end to pointed end, the coherent corkscrew beam of plasma ions flows forward with ever smaller radius, getting ever hotter, denser, narrower, and faster in both orbital and forward speed until it enters into a small diameter linear accelerator;
c) flowing within the conical flow channel, a coherent corkscrew beam of plasma ions is subjected to electrical repulsive forces from the non-conducting inner cone filled with a volume of positively charged particles, orbital centripetal inertia forces, and magnetic confinement forces; these three forces are balanced for plasma ions to flow forward without frictions within the conical flow channel; and the net forces applied on plasma ions are zero in radial force component, and forward in forward force component;

4. Corkscrew NFR, as recited in claim 3, comprises further some not so unique methods commonly found on some currently known NFRs, including methods to accelerate, superheat, confine and compress plasma ions, wherein:
a) a linear accelerator, multiple heating elements, magnetic confinements, and magnetic cusps act separately and in combination to speed up, focus, steer, superheat and transform a corkscrew beam of plasma ions entering and passing through the linear accelerator and the combustion chamber; the corkscrew beam of plasma ions is transformed to a beams of pulsed and segmented plasma ions; and upon hitting on target at the mid-plane of rotational symmetry, each of two forward flowing coherent counter-rotating transformed beams of pulsed and segmented plasma ions is at the maximum for extremely high temperature and density, extremely fast in orbital and forward speed, and extremely small in orbital radius; and
b) magnetic cusps at mi-plane of rotational symmetry trap, confine, and compress violently head-on collisions of two forward flowing coherent counter-rotating beams of plasma ions; and plasma ions, by been dense enough at high enough temperature for long enough period of time, are fused, ignited, and burned in sustained nuclear fusion reactions.
